(19) United States
(12) Patent Application Publication
(10) Pub. No.: US 2025/0157688 A1
(43) Pub. Date: May 15, 2025

(54) ELECTROCONDUCTIVE MULTILAYER BODY AND METHOD FOR PRODUCING THE SAME

(71) Applicant: TANAKA KIKINZOKU KOGYO K.K., Tokyo (JP)

(72) Inventors: Shigeyuki OOTAKE, Tsukuba-shi (JP); Yuusuke OHSHIMA, Tsukuba-shi (JP); Hiroki SATO, Tsukuba-shi (JP); Yuki FUJITA, Tsukuba-shi (JP)

(73) Assignee: TANAKA KIKINZOKU KOGYO K.K., Tokyo (JP)

(21) Appl. No.: 18/722,713

(22) PCT Filed: Dec. 20, 2022
(86) PCT No.: PCT/JP2022/046840

§ 371 Date: Jan. 23, 2025

(30) Foreign Application Priority Data
Dec. 22, 2021 (JP) 2021-208584

(51) Int. Cl. H01B 5/14; H01B 1/02; H01B 3/30; H01B 13/00

(52) U.S. Cl. CPC H01B 5/14; H01B 1/02; H01B 13/0016; H01B 3/30

(57) ABSTRACT

The present invention relates to an electroconductive multilayer body having a substrate/ITO layer/Ag layer multilayer configuration including a substrate, an ITO layer containing indium tin oxide formed on at least a part of one surface or both surfaces of the substrate, and a Ag layer containing Ag formed on at least a part of the ITO layer. In the present invention, a binder layer containing a polymer is provided between the ITO layer and the Ag layer. This binder layer includes a polymer having a main chain of a straight chain, and having an OH group and/or a COOH group as a side chain. The electroconductive multilayer body of the present invention is produced by applying a polymer such as polyacrylic acid onto the ITO layer to form the binder layer, and applying and calcining a Ag ink containing a Ag particle to form the Ag layer.

### CROSS-REFERENCE TO RELATED APPLICATIONS

The present application claims priority under 35 U.S.C. § 371 to International Patent Application No. PCT/JP2022/046840, filed Dec. 20, 2022, which claims priority to and the benefit of Japanese Patent Application No. 2021-208584, filed on Dec. 22, 2021. The contents of these applications are hereby incorporated by reference in their entireties.

### BACKGROUND OF THE INVENTION

### Field of the Invention

The present invention relates to an electroconductive multilayer body in which a Ag metal layer is formed on an ITO layer containing indium tin oxide formed on an appropriate substrate. More particularly, it relates to an electroconductive multilayer body excellent in bondability/adhesiveness between an ITO layer and a Ag metal layer.

### Description of the Related Art

As an electrode substrate such as a touch panel of a smartphone, a tablet, a PC display or the like, an electroconductive multilayer body having transparency has been used. Such an electroconductive multilayer body has a multilayer structure including an electrode layer formed on a substrate of glass, a resin or the like. In the above-described various applications, the electrode layer requires translucency and conductivity, and indium tin oxide (ITO) is applied to the electrode layer in many cases. Such an electroconductive multilayer body has a basic structure in which a single layer of an ITO layer formed on a substrate (hereinafter, an electroconductive multilayer body including an ITO layer is formed on a substrate is sometimes referred to as an ITO substrate). The electroconductive multilayer body may further require one or more electrode layers on the ITO layer of the ITO substrate in some cases.

For example, in recent years, compact equipment of a smartphone or the like having a foldable touch screen have been released. Besides, a wearable device is required to employ a curved design, or to be deformable for following the movement of a body in consideration of comfortableness to wear and fashionability. In a touch screen of such electronic equipment, a flexible organic material such as a PET film is used as a substrate, an ITO layer is applied to an electrode in a plane region not bent, and a metal wiring excellent in bending deformation resistance is applied to an electrode in a bending portion in some cases. This is because an oxide material such as ITO is a material comparatively fragile as compared with a metal, and hence is so poor in bending deformation resistance that it may be broken. Besides, in order to cope with bending deformation, the electrode needs to be thin, but ITO is a material having a comparatively high resistance value, and it is concerned that the resistance value may be increased when thinned. When an ITO layer and a metal electrode are thus used together, a structure in which a metal layer is stacked on the ITO layer is required for electric connection therebetween.

The present applicant has proposed a method for forming a metal electrode/wiring, in which a metal layer (Ag layer) based on printed electronics technology using a Ag ink (Ag paste) is applied. Ag is known as a metal having low resistance, and is optimum as an electrode material. Besides, a silver layer formed by applying and calcining a Ag ink contains a sintered body of Ag particles, and is comparatively flexible and also has bending resistance. Besides, when the Ag layer is formed into an extra fine wire beyond the human visible range, substantial translucency can be obtained. In addition, the printed electronics technology is a method for forming a Ag layer by applying and calcining a Ag ink, and hence is excellent in efficiency and productivity (continuous productivity). The formation of a Ag layer with a Ag ink enables formation of a Ag layer having a large area, and also has an advantage that a Ag layer of the extra fine wire with translucency as described above can be formed by controlling the composition of the metal ink and application conditions.

The present applicant has revealed a large number of related arts regarding various Ag inks and metal wirings for expanding the applicable range of metal wirings/metal layers based on the printed electronics technology (Patent Documents 1 to 4). In a basic aspect of the Ag ink in these related arts proposed by the present applicant, Ag particles protected by a protective agent such as an amine are dispersed in an appropriate solvent. The resultant Ag ink can be sintered at a comparatively low temperature, and can produce a Ag wiring with low resistance (Patent Documents 1 and 2). Besides, according to the technique of forming a metal wiring proposed by the present applicant, an extra fine high-definition Ag layer pattern having translucency can be formed (Patent Documents 3 and 4).

### PRIOR ART DOCUMENT

### Patent Document

### Patent Document 1

Japanese Patent No. 5795096

### Patent Document 2

Japanese Patent No. 6491753

### Patent Document 3

Japanese Patent No. 5916159

### Patent Document 4

Japanese Patent No. 6946775

### SUMMARY OF THE INVENTION

### Technical Problem

In the production process of a Ag layer using a Ag ink proposed by the present applicant, the type of a substrate is not basically limited. Therefore, it is presumed that an electroconductive multilayer body can be also produced by applying a Ag ink to an ITO layer. In such a multilayer body, however, adhesiveness between the ITO layer and the Ag layer is required. In this regard, the present inventors have made preliminary studies on formation of a Ag layer on an ITO layer with a Ag ink, resulting in finding that although the Ag layer is tentatively fixed, the Ag layer is peeled off through deformation of the substrate or with a slight scratch.

The present invention was devised under such a background, and provides an electroconductive multilayer body that includes a Ag layer containing Ag formed on an appropriate substrate and an ITO layer, and is excellent in adhesiveness between the ITO layer and the Ag layer. In addition, the present invention reveals a method for producing the electroconductive multilayer body by which a Ag layer is favorably formed by printed electronics technology using a Ag ink.

### Solution to Problem

The present invention solving the above-described problem is drawn to an electroconductive multilayer body, including a substrate, an ITO layer containing indium tin oxide formed on at least a part of one surface or both surfaces of the substrate, and a Ag layer containing Ag formed on at least a part of the ITO layer, and further including a binder layer containing a polymer between the ITO layer and the Ag layer, and the polymer includes a polymer having a main chain of a straight chain, and having an OH group and/or a COOH group as a side chain.

As a method for improving adhesiveness of a Ag ink to an application target (an ITO layer in the present invention), a method in which an additive for improving the adhesiveness of the Ag ink is added can be employed. It is concerned, however, that the additive in the Ag ink may remain in the Ag layer after applying/calcination. Such a residue increases the resistance value of the Ag layer, and hence is not preferable in consideration of use as an electrode/wiring. Besides, the additive can inhibit sintering of Ag particles to impair low-temperature sinterability. In consideration of these disadvantages, in the present invention, the adhesiveness of the Ag ink and a sintered body obtained after sintering is improved, with the composition of the Ag ink set within the range of the conventional technique, by modifying the surface of the ITO layer with a prescribed polymer. Now, an electroconductive multilayer body of the present invention and a method for producing the same will be described.

### (A) Composition of Conductive Multilayer Body of the Invention

### (a) Substrate

A substrate applied in the present invention need not be especially limited, a substrate of a metal or ceramic can be applied, and alternatively, a substrate of an organic material such as a resin or a plastic is applicable. Besides, various glass can be used. The present invention is favorably used in a display device such as a touch panel or a display, and in such an application, a substrate of a transparent body is preferably used. Specific examples of the material include glass, polyethylene terephthalate (PET), polyimide (PI), polyamide, a cycloolefin polymer (COP), and polyurethane.

### (b) ITO Layer

Indium tin oxide is an oxide material including a mixture of indium oxide (In₂O₃) and tin oxide (SnO₂). The ITO layer of the present invention contains indium tin oxide conventionally known. A mixing ratio between indium oxide and tin oxide can be freely set. Indium tin oxide having a content ratio of Sn (Sn/(In+Sn)) of 5 to 15% in terms of % by mass is well known, and the mixing ratio is not restricted in the present invention. Besides, indium tin oxides, used as an ITO layer, are known to have both amorphous and crystalline structures, and either may be used in the present invention. It is known that an amorphous ITO thin film is changed to be crystalline by heating (at about 150° C. or more).

Besides, the characteristics of an ITO layer vary depending on a production method and production conditions, but a method for producing the ITO layer is not limited in the present invention. As the method for producing an ITO layer, thin film production processes such as a sputtering method, a vacuum deposition method, and a CVD method are well known. Besides, a method for forming an ITO layer by applying a slurry of powdery indium tin oxide by a spraying method, a spin coating method, a dip coating method or the like is also known.

The thickness of the ITO layer in the electroconductive multilayer body of the present invention is not especially limited, and is preferably 0.01 μm or more and 1.0 μm or less. When the thickness is smaller than 0.01 μm, the resistance value is increased, and when it is larger than 1.0 μm, the resultant layer is not suitably used as a transparent electrode from the viewpoint of transmittance. Besides, the ITO layer may be formed on at least a part of the substrate surface, and need not be formed on the whole substrate surface.

### (c) Ag Layer

When the Ag layer is formed on the substrate including the ITO layer described above, the electroconductive multilayer body of the present invention is obtained. The Ag layer may at least partly overlap the ITO layer to form a multilayer structure. The plane size of the Ag layer is not especially limited. On the other hand, the thickness of the Ag layer is preferably 0.02 μm or more and 10 μm or less. An excessively thick Ag layer is poor in flexibility, and may be damaged or increased in the resistance value when deformed, for example, bent. On the other hand, when the thickness is excessively small, it is concerned that uniformity in the resistance value is deteriorated. The thickness of the Ag layer is more preferably 1 μm or less.

In the present invention, the Ag layer preferably contains a sintered body of Ag particles. A sintered body in the present invention means a state where adjacent Ag particles are bonded to one another, and are bonded with a force sufficient for avoiding the sintered body from collapsing under its own weight, or larger force. It is not limited to a state where particles are firmly bonded to one another through plastic deformation or necking of the constituent particles as in a “sintered body” formed by general powder metallurgy. The Ag particles of the sintered body contained in the Ag layer have an average particle size of preferably 10 nm or more and 300 nm or less. It is concerned that a sintered body of Ag particles of 10 nm or less may be excessively dense to be poor in flexibility. Besides, a sintered body of Ag particles exceeding 300 nm may have so many voids that the resistance value is increased in some cases.

The purity of the Ag particles contained in the Ag layer of the present invention is preferably 97% by mass or more. When the purity is less than 97% by mass, the sintering temperature may be increased, and the electric resistance value may be increased. The purity of the Ag particles can be measured by performing, with a cross-section observed with an electronic microscope (SEM) or the like, EPM (electron probe microanalysis) or EDX (energy dispersive X-ray analysis) on the Ag particle portions.

The sintered body contained in the Ag layer is preferably in a state where the Ag particles are appropriately bonded. This bonding state can be estimated based on the hardness of the Ag layer, and the hardness of the Ag layer is preferably 0.1 GPa or more and 0.5 GPa or less. The hardness of the Ag layer can be measured by a nanoindentation method. The nanoindentation method is a measurement method using a specific measuring apparatus (nanoindenter), in which the hardness is measured based on a load and an indentation depth obtained in pushing a pressure head provided in the measuring apparatus into a measurement target. The load applied by the pressure head of the nanoindenter is precisely controlled by electromagnetic control, and the movement of the head is also electrically precisely measured. In the nanoindenter measurement, contact rigidity (stiffness) and contact depth of a sample can be obtained, and the hardness and Young's modulus can be calculated therefrom. The nanoindentation method is standardized as a micro-indentation test by International Organization for Standardization (ISO) (ISO 14577).

### (d) Binder Layer

The electroconductive multilayer body of the present invention includes a binder layer containing a polymer on the binding interface between the ITO layer and the Ag layer. The binder layer is an essential composition of the present invention for improving adhesiveness between the Ag layer and the ITO layer. The binder layer is preferably formed wholly on a contact region between the Ag layer and the ITO layer.

The polymer contained in the binder layer includes a polymer having, in a chemical structure thereof, a main chain of a straight chain, and an OH group and/or a COOH group as a side chain. Since the ITO layer is hydrophilic, when a polymer having an OH group and/or a COOH group on the side chain is applied, electrostatic interaction such as a hydrogen bond is formed to ensure the adhesiveness between the ITO layer and the Ag layer. A polymer having a main chain of straight chain is applied for ensuring flexibility following deformation, with adhesiveness maintained, for the substrate and the ITO layer that can be bending-deformed.

As a detail of the composition of the polymer, a polymer containing a monomer unit that has a main chain of a saturated hydrocarbon chain containing C and H, and having 2 or more and 5 or less carbon atoms, and has an OH group and/or a COOH group as a side chain is preferred. Examples of the polymer include any one of polyacrylic acid, polyvinyl alcohol (PVA), and polyvinyl acetal. It has been confirmed, through studies made by the present inventors, that such a polymer can impart very high adhesiveness to the Ag layer. In examples of the polymer represented by the following formulas, polyvinyl acetal is preferably polyvinyl acetoacetal (R═CH₃) or polyvinyl butyral (R═C₃H₇), and one having a compounding ratio of a hydroxyl group of 20% by mol or more and 40% by mol or less, and having an acetalization degree of 60% by mol or more and 75% by mol or less is preferred.

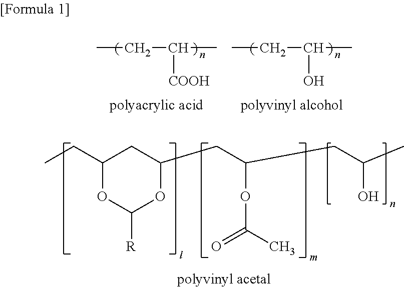

When the average molecular weight of the polymer contained in the binder layer is too low, the resultant has high flowability, and may scatter in a Ag ink applying step, a calcining step, or the like, and hence the binder layer is insufficiently formed on the ITO layer, and therefore, it is concerned that the adhesiveness of the Ag layer may be reduced. On the other hand, when the average molecular weight of the polymer is high, the movement of the resultant on the ITO layer surface may be restricted, which may make the binder layer uneven. From these points of view, the average molecular weight of the polymer is preferably 1000 or more and 1000000 or less, more preferably 1000 or more and 500000 or less, and particularly preferably 1000 or more and 200000 or less. The average molecular weight of the polymer does not, however, harmfully affect the adhesiveness itself, and hence, even a polymer having a high molecular weight can impart the effect of improving the adhesiveness to the Ag layer to a region where it is applied. It is noted that the average molecular weight of a polymer refers to a mass average molecular weight (MW) in the present invention.

The binder layer preferably contains only the polymer described above, but may contain another polymer or monomer with the polymer contained as a principal component. For example, with any one of polyacrylic acid, polyvinyl alcohol, and polyvinyl acetal contained as a principal component, a polymer such as polyvinyl pyrrolidone, polyethylene glycol, methyl polyacrylate, or polyethylene imine may be contained. As mentioned as the principal component above, however, the binder layer contains the above-described polymer preferably in an amount of 80% by mol or more.

The polymer contained in the binder layer of the electroconductive multilayer body of the present invention is detectable by various analysis methods. As an analysis method for the binder layer, TOF-SIMS (Time-of-Flight Secondary Ion Mass Spectrometry) can be employed for obtaining ratios among respective elements contained in the binder layer and chemical structure information of the polymer. In employing MALDI-TOF-MS (Matrix-Assisted Laser Desorption/Ionization Time-of-Flight Mass Spectrometry), the molecular weight of the polymer can be evaluated. A general-purpose polymer can be checked referring to database of fragment patterns or monomer molecular weights. Besides, in employing FT-IR (Fourier Transform Infrared Spectroscopy) or TG-DTA-MS (Thermogravimetry-Differential Thermal Analysis and Mass Spectrometry), a functional group of the side chain of the polymer can be evaluated. When one or more of these analysis methods are appropriately performed, the composition of the binder layer can be estimated.

The thickness of the binder layer can be evaluated by observing the cross-section of the electroconductive multilayer body with an electronic microscope (SEM or TEM). In the cross-section observation with an SEM or TEM, a clearance is observed between the ITO layer and Ag layer, and since this clearance corresponds to the thickness of the binder layer, the width of the clearance is measured. In the present invention, the thickness of the binder layer is preferably 0.5 nm or more and 50 nm or less. When the thickness is less than 0.5 nm, the function as the binder layer is insufficient. When the thickness exceeds 50 nm, it is difficult to ensure the conductivity between the Ag layer and the ITO layer.

The ITO layer, the binder layer, and the Ag layer described so far may be formed on one surface or both surfaces of the substrate.

### (B) Method for Producing Conductive Multilayer Body of the Invention

Next, a method for producing an electroconductive multilayer body of the present invention will be described. The electroconductive multilayer body of the present invention is novel, but a conventional one can be applied as a substrate including an ITO layer (ITO substrate), which can be produced by a sputtering method or the like described above. Besides, for forming a Ag layer, the printed electronics technology utilizing a known Ag ink such as the Ag ink proposed by the present applicant described above can be applied. The production of the electroconductive multilayer body of the present invention has a characteristic only in forming a binder layer by applying the above-described polymer before forming the Ag layer. Specifically, the method for producing an electroconductive multilayer body of the present invention includes a step of providing an ITO substrate in which an ITO layer is formed on at least a part of one surface or both surfaces of a substrate, a step of applying a polymer solution containing a polymer to a surface of the ITO layer of the ITO substrate to form a binder layer, and a step of applying, to a surface of the binder layer, a Ag ink essentially containing a Ag particle and a solvent, and then calcining the resultant at 80° C. or more and 150° C. or less to form a Ag layer. Now, the respective steps of the method for producing an electroconductive multilayer body will be described in detail.

### (a) Providing ITO Substrate

As the ITO substrate, a known substrate may be provided as described above. In the production of the ITO substrate, the ITO layer can be formed on the substrate by a sputtering method or the like.

### (b) Formation of Binder Layer

The binder layer is formed on the ITO layer with a polymer solution containing the above-described polymer applied to the ITO substrate. The solvent of the polymer solution is not especially limited, and a solvent in accordance with the type of the polymer is selected. A commercially available polymer solution may be used, or may be appropriately diluted for adjusting the concentration. The concentration of the polymer in the polymer solution is preferably 0.5% by mass or more and 10% by mass or less. When the polymer concentration is less than 0.5% by mass, it is concerned that a polymer molecule may not be disposed in a region necessary on the ITO layer. The binder layer can exhibit adhesiveness even when it contains a polymer of a single molecule to about several molecules with a thickness of 0.5 nm or more. When the polymer concentration in the polymer solution is too low, however, it is concerned that a region having no polymer may be partially formed. On the other hand, when the polymer solution has a polymer concentration exceeding 10% by mass, the polymer is excessively adhered, which increases the resistance value between the Ag layer and the ITO layer.

It is preferable, in the polymer solution, that only the polymer is dissolved or dispersed in a solvent in the above-described concentration, and another polymer or the like may be added thereto. It is, however, preferable that the addition of another polymer is up to 20% by mass or less based on the above-described polymer.

A method for applying the polymer solution is not especially limited, and not only a spin coating method, a dipping method, a dropping method, and application with a squeegee or brush but also a printing method such as an inkjet method may be applied. The coating method may be any method as long as the polymer solution can be uniformly applied to a region where the binder layer and the Ag layer are to be formed. Besides, the polymer solution may be applied after masking with a photoresist or the like.

After applying the polymer solution, the resultant may be dried if necessary for volatilizing the solvent of the polymer solution. When a solvent with high volatility is used, however, there is no need to additionally set a drying step. Besides, depending on the type of the polymer, a calcining treatment may be performed as a treatment following the application of the polymer solution. Through the calcination, the solvent is volatilized, the polymer is spread over the surface of the ITO layer to form the binder layer in a desired region, so that the adhesiveness to the Ag layer can be improved in some cases. When such a preliminary calcination treatment for the polymer is performed, heating is preferably performed at 50° C. or more and 150° C. or less for 1 minute or more and 300 minutes or less. The preliminary calcination of the polymer is, however, an optional step. For example, when polyacrylic acid is used as the polymer, there is no need to perform the preliminary calcination step.

### (c) Formation of Ag Layer

After forming the binder layer, the Ag layer is formed by applying and calcining the Ag ink, and thus, the electroconductive multilayer body of the present invention is produced.

### (i) Ag Ink

A Ag ink contains a solid content of Ag particles dispersed in a solvent as a basic composition, and an additive is optionally contained. The Ag particles of the solid content have an average particle size of 10 nm or more and 300 nm or less, and at least one amine compound having 4 or more and 8 or less carbon atoms is bonded to the Ag particles as a protective agent. The range of the particle size of the Ag particles is specified as an average particle size of 10 nm or more and 300 nm or less because thus, a Ag sintered body free from a crack can be formed at a temperature equal to or lower than the decomposition temperature of ITO. In using excessively fine Ag particles having an average particle size less than 10 nm, the volumetric shrinkage rate at the time of sintering is so high that the resultant Ag film may be cracked, which can be a cause of disconnection. In using Ag particles having an average particle size exceeding 300 nm, the sintering temperature needs to be set rather high, and the electric resistance value is increased when sintered at a low temperature. The average particle size of the Ag particles is preferably 20 nm or more and 200 nm or less, more preferably 30 nm or more and 120 nm or less, and further preferably 40 nm or more and 80 nm or less.

As the particle size distribution of the Ag particles, a coefficient of variation corresponding to a ratio between the standard deviation of the particle size and the average particle size (standard deviation/average particle size) is preferably 0.05 or more and 0.5 or less. For ensuring the adhesiveness between the Ag layer and the ITO layer via the binder layer, and the flexibility of the Ag layer, the particle size distribution of the Ag particles is caused to have moderate variation and convergence. Besides, assuming that the Ag layer is formed on the substrate in a thickness of several tens nm, the variation in the particle size of the Ag particles directly leads to the variation in the thickness of the Ag layer, which also increases surface roughness. When the surface roughness is increased, it is concerned that a defect may be caused in applying or stacking an insulating material or the like on the surface of the Ag layer. The particle size distribution is specified also in consideration of this point.

The Ag particles in the Ag ink are dispersed in the solvent in a state bonded to an amine compound, used as the protective agent, having 4 to 8 carbon atoms on average. The protective agent is a compound bonding to a part or the whole of a Ag particle, and is used for inhibiting aggregation of the Ag particles in the ink. One or a plurality of amine compounds are bonded to the Ag particles as the protective agent. At this point, the protective agent bonding to the Ag particles is preferably an amine compound having 4 to 8 carbon atoms on average as a whole. The number of carbon atoms on average as a whole refers to the number of carbon atoms calculated, with respect to one or a plurality of amine compounds contained in a metal paste, by dividing the numbers of carbon atoms thereof by the amount added (mole fraction). This is, assuming that the amine compounds contained in the metal paste are uniformly bonded to the Ag particles, an average of the numbers of carbon atoms thereof.

The protective agent applied in the present invention is limited to an amine compound for ensuring the low-temperature sinterability of the Ag ink. An amine compound volatilizes at a comparatively low temperature, and can accelerate sintering among the Ag particles. The amine compound used as the protective agent preferably has 4 to 8 carbon atoms on average as described above, because an amine having less than 4 carbon atoms on average is poor in protective effect, and it is difficult, with it, to cause the Ag particles to be stably present. On the other hand, in using an amine having more than 8 carbon atoms on average, a sintering temperature for forming a wiring with a prescribed low resistance value needs to be set to a high temperature. It is noted that an amine having 9 or more carbon atoms with a comparatively large carbon atoms can be added as long as the average number of carbon atoms of the protective agent molecules is 8 or less. For example, a mixture of an amine having 4 carbon atoms and an amine having 12 carbon atoms can be used as the protective agent. In this case, the average number of carbon atoms per molecule may be 8 or less.

As the amine compound, a (mono)amine having one amino group, or a diamine having two amino groups can be applied. The number of hydrocarbon groups bonding to the amino group is preferably 1 or 2, and a primary amine (RNH₂) or a secondary amine (R₂NH) is preferred. When a diamine is applied as the protective agent, one in which at least one or more amino groups are primary amines or secondary amines is preferred. A hydrocarbon group bonding to an amino group may be not only a chain hydrocarbon having a straight chain structure or branched structure but also a hydrocarbon group having a cyclic structure. Besides, oxygen may be partly contained therein.

Specific preferable examples of the protective agent applied in the present invention include amine compounds such as butylamine (number of carbon atoms: 4), 1,4-diaminobutane (number of carbon atoms: 4), 3-methoxypropylamine (number of carbon atoms: 4), pentylamine (number of carbon atoms: 5), 2,2-dimethylpropylamine (number of carbon atoms: 5), 3-ethoxypropylamine (number of carbon atoms: 5), N,N-dimethyl-1,3-diaminopropane (number of carbon atoms: 5), hexylamine (number of carbon atoms: 6), heptylamine (number of carbon atoms: 7), benzylamine (number of carbon atoms: 7), N,N-diethyl-1,3-diaminopropane (number of carbon atoms: 7), octylamine (number of carbon atoms: 8), 2-ethylhexylamine (number of carbon atoms: 8), nonylamine (number of carbon atoms: 9), decylamine (number of carbon atoms: 10), and dodecylamine (number of carbon atoms: 12).

The amount of the protective agent (amine compound) in the Ag ink of the present invention is preferably 1000 ppm or more and 30000 ppm or less based on the weight of the Ag ink. When the amount is less than 500 ppm, the protective effect for the Ag particles is insufficient, and dispersibility of the Ag particles in the Ag ink is reduced. When the amount exceeds 30000 ppm, it may remain in the sintered body, and may affect the hardness and the Young's modulus of the sintered body.

As a method for producing the Ag particles containing the protective agent described above, a thermal decomposition method using a thermally decomposable silver compound as a raw material is favorable. In the thermal decomposition method, a silver compound, such as silver oxalate (Ag₂C₂O₄), silver formate (AgH₂CO₂), silver carbonate (Ag₂CO₃), or silver oxide (Ag₂O), capable of precipitating silver through thermal decomposition is used as a raw material, an organic compound such as an amine is mixed with the raw material to form a silver-amine complex, and this complex is heated/decomposed to precipitate Ag particles. The Ag ink can be produced by collecting the thus precipitated Ag particles, and adding the particles to a solvent. The amine compound used as the protective agent of the Ag particles has been added at the stage where the silver-amine complex is generated.

Besides, the solvent of the Ag ink for dispersing the Ag particles therein is preferably an organic solvent having 0 to 16 carbon atoms and a boiling point of 280° C. or less. The solvent needs to be volatilized/removed in sintering the Ag particles after applying the Ag ink. In order to sinter the Ag particles and remove the solvent at a comparatively low temperature, a solvent having a boiling point of 280° C. or less is preferred. Specific preferable examples of the solvent include methanol (C1, boiling point: 65° C.), ethanol (C2, boiling point: 78° C.), 1-propanol (C3, boiling point: 97° C.), 2-propanol (C3, boiling point: 90° C.), 1-butanol (C4, boiling point: 118° C.), acetone (C3, boiling point: 56° C.), toluene (C3, boiling point: 110° C.), terpineol (C10, boiling point: 219° C.), dihydroterpineol (C10, boiling point: 220° C.), texanol (C12, boiling point: 260° C.), 2,4-dimethyl-1,5-pentanediol (C9, boiling point: 150° C.), and 2,2,4-trimethyl-1,3-pentanediol isobutyrate (C16, boiling point: 280° C.). A mixture of a plurality of solvents may be used, or a single one of these may be used.

The content of the Ag particles in the Ag ink is preferably 5% by mass or more and 80% by mass or less based on the mass of the whole Ag ink. The thickness of the Ag layer can be controlled by adjusting the content of the Ag particles in the Ag ink. When the content is less than 5% by mass, however, the Ag layer may be too thin, or uneven in the thickness. On the other hand, when the Ag ink contains the Ag particles in a content exceeding 80% by mass, the viscosity is so high that a uniform coating film of 10 μm or less is difficult to form.

It is noted that the Ag ink used in the present invention can contain an organic compound as an optional additive. Specifically, a primer or the like can be added thereto for improving adhesiveness to a printing substrate. When printing is performed at a comparatively high viscosity as in screen printing, a thixotropic agent is added in some cases for improving printability. The content of such optional organic additives, in total, is preferably 2% by weight or less based the weight of the ink.

### (ii) Ag Ink Application Step

An application method employed in applying the Ag ink described above to the ITO layer is not especially limited. When the Ag layer is formed in a fine pattern of the printed electronics technology, a printing method such as screen printing or inkjet printing can be applied. The method is, however, not limited to these, and dipping, spin coating, or a dropping method using an application member such as a roll coater, or a blade/squeegee may be employed. The printing/applying method is appropriately selected in accordance with the pattern shape and the thickness of the Ag layer to be formed.

(iii) Calcining Step (Step of Sintering Ag Particles)

After applying the Ag ink to the ITO substrate, the resultant is subjected to a calcining treatment for sintering the Ag particles, and thus, the Ag layer is formed. In the calcining treatment, sintering of the Ag particles is caused to progress as well as a component of the protective agent or the like that can remain in the metal film is removed. The calcining treatment is performed at 80° C. or more and 180° C. or less. When the temperature is less than 80° C., it takes a long time to eliminate or volatilize the protective agent, and also the progress of the sintering is liable to be insufficient. On the other hand, when the temperature exceeds 180° C., it is concerned that the ITO layer may be affected, and the substrate may be also affected depending on the material. A preferable calcining temperature is 80° C. or more and 150° C. or less, and more preferably 80° C. or more and 120° C. or less. The calcining time is preferably 1 minute or more and 600 minutes or less. It is noted that the calcining step may be performed under the air atmosphere, or may be performed under an inert gas atmosphere or vacuum atmosphere.

Through the calcining treatment, the Ag particles in the Ag ink are bonded/sintered to form the Ag layer, and thus, the electroconductive multilayer body of the present invention is produced.

### Advantageous Effects of Invention

As described above, an electroconductive multilayer body of the present invention is an electroconductive material in which a Ag layer containing Ag is stacked on an ITO substrate having an ITO layer. In the present invention, a binder layer containing a prescribed polymer is provided between the ITO layer and the Ag layer, and as a result, adhesiveness of the Ag layer is favorable.

### BRIEF DESCRIPTION OF THE DRAWINGS

FIGS. 1(a) and 1(b) show photographs of a form on a surface (Ag layer) and a cross-sectional form of an electroconductive multilayer body produced in Example 1 of First Embodiment.

### DETAILED DESCRIPTION OF THE PREFERRED EMBODIMENTS

First Embodiment: A preferred embodiment of the present invention will now be described. In the present embodiment, after forming a binder layer by applying each of various polymers on an ITO substrate, a Ag layer was formed with a Ag ink applied/calcined to produce an electroconductive multilayer body. Then, the resistance value of the Ag layer was measured, and adhesiveness evaluation test was performed.

### [Providing ITO Substrate]

An ITO substrate in which an ITO film was formed on the whole surface of a glass substrate (30 mm×30 mm) by a sputtering method was produced. The thickness of the ITO layer was 200 nm. The ITO layer contained indium tin oxide having a tin oxide content of 10%.

### [Formation of Binder Layer]

A binder layer was formed with a polymer solution applied on the ITO substrate. Polymers used here were polyacrylic acid (average molecular weight: 150000), polyvinyl butyral (average molecular weight: 110000), and polyvinyl alcohol (average molecular weight: 20000). These polymers were commercially available products, and were diluted with a solvent (2-propanol, or toluene) to obtain polymer solutions having a polymer concentration of 1.0% by mass.

The polymer solution was applied by a spin coating method. Spin coating conditions were set to a rotational speed of the ITO substrate of 3000 rpm, and keeping time of 30 sec. After applying the polymer solution, the resultant ITO substrate was subjected to preliminary calcination by heating in the air at 120° C. for 30 minutes, and thus, a binder layer was formed.

[Formation of Ag layer]

A solution in which Ag particles produced by a thermal decomposition method were dispersed in IPA used as a solvent was produced as a Ag ink. In the production of the Ag particles, 102.2 g of silver carbonate (silver content: 80.0 g) was used as a silver compound corresponding to a raw material. This silver compound was provided in a wet form by adding 37.3 g (36.4% by weight based on 100 parts by mass of the silver carbonate) of ion exchange water thereto. Then, 3-methoxypropylamine was added (in a 6-fold amount, in terms of a molar ratio, relative to the mass of silver in the silver compound) as an amine compound used as a protective agent to produce a silver-amine complex. The silver-amine complex was stirred under heating from room temperature, and thus, the silver-amine complex was decomposed to precipitate silver particles. The heating temperature at this point was 140° C. After the heating, the resultant reaction solution was cooled to room temperature, an organic solvent (Nikko NG-120) was added to the reaction solution, and the resultant was washed and filtered under pressure to collect Ag particles.

Regarding the Ag particles produced in the present embodiment, the average particle size and the particle size distribution of the Ag particles were measured. In this measurement, a metal paste was appropriately sampled for SEM observation, and in the thus obtained SEM image, 500 silver particles were measured individually for their particle sizes by a biaxial averaging method to calculate an average value (median diameter) and a standard deviation. The Ag particles produced in the present embodiment had an average particle size of 80 nm, and a standard deviation of 30 nm (coefficient of variation: 0.4). Then, the Ag particles were dispersed in IPA to a Ag concentration of 20% by mass to obtain a Ag ink.

Then, the Ag ink was applied to the ITO substrate having the binder layer formed thereon. The Ag ink was applied by a spin coating method. The spin coating conditions were set to a rotational speed of the ITO substrate of 3000 rpm, and time of dropping the solution of 30 sec. After applying the Ag ink, a calcining treatment for heating the resultant in the air at 120° C. for 30 minutes was performed to form a Ag layer, and thus, an electroconductive multilayer body was produced.

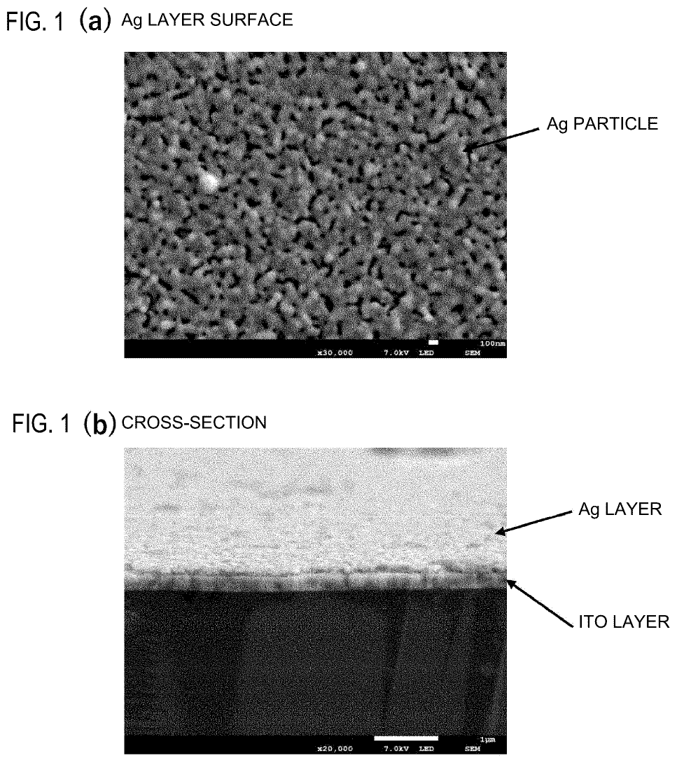

FIGS. 1(a) and 1(b) show an SEM image (FIG. 1(a)) of a Ag layer surface and a cross-sectional SEM image (FIG. 1(b)) of the electroconductive multilayer body (binder layer: polyacrylic acid) of Example 1. It was confirmed, based on the surface SEM image, that the Ag layer contains a sintered body of the Ag particles. Besides, based on the cross-sectional SEM image, formation of the binder layer was confirmed because of a clearance between the Ag layer and the ITO layer, and the thickness was estimated as 10 nm. It is noted that a similar cross-sectional form was observed in conductive multilayer bodies of Examples 2 and 3, and the thickness of the binder layer was about 10 nm.

Comparative Example: As comparative examples to the examples of the present embodiment, various polymers and monomers were applied on an ITO substrate to form a Ag layer to thereby produce electroconductive multilayer bodies. In the comparative examples, sodium polyacrylate (average molecular weight: 40000), polyvinyl pyrrolidone (average molecular weight: 20000), and ethyl cellulose (average molecular weight: 50000) as polymers, and citric acid, sodium acetate, oleic acid, oxalic acid, oleylamine, hexylamine, and diamine N,N-dimethyl-1,3-propaneamine as monomers were applied (all in a concentration of 1.0% by mass). Application method and conditions were the same as those employed in the present embodiment. Then, a Ag ink similar to that of the present embodiment was applied/calcined to form a Ag layer, and thus, an electroconductive multilayer body was produced.

In addition, as a comparative example corresponding to a blank, an electroconductive multilayer body in which a Ag ink was applied on an ITO substrate without applying any other thing thereto was produced.

Reference Example: Regarding the polymers used as the binder layer in the present embodiment, in order to confirm the adhesiveness of the Ag layer to a substrate except for the ITO substrate, a sample using a glass plate as the substrate was produced. A polymer (polyacrylic acid or polyvinyl butyral) used in the binder layer was applied to the substrate used in the present embodiment without forming an ITO layer thereon, and the Ag ink was applied/preliminarily calcined. The methods for applying the polymer solution and the Ag ink and the conditions of the preliminary calcination/calcination were the same as those employed in First Embodiment.

Regarding each of the electroconductive multilayer bodies produced in the examples, the comparative examples, and the reference examples described above, the appearance was evaluated, the resistance value was measured, and the adhesiveness was evaluated. For the appearance evaluation, the surface of the Ag layer was visually observed to confirm presence/absence of peeling of the Ag layer and presence/absence of metallic luster. At this point, one having no peeling on the whole surface and having uniform metallic luster was evaluated as “excellent”, and one having slight haze but having the metal film on the whole surface was evaluated as “good”. On the other hand, one having no metallic luster or having no Ag film formed on the front surface was evaluated as “failure”. Besides, the Ag layer of each sample was measured for the sheet resistance (Ω/□) with a digital tester. It is noted that 15Ω/□ or less was assumed as a standard of a favorable resistance value of the Ag layer.

The evaluation of the adhesiveness was performed by subjecting the Ag layer of each conductive multilayer body to a cross-cut test. In the cross-cut test, the Ag layer surface of each sample was cross-cut into a grid pattern with a cutter to form 25 squares each of 1 mm×1 mm. Then, an adhesive release tape (manufactured by 3M Japan Ltd., trade name: Scotch #610) was attached onto the cross-cut region, and an area ratio of a region in which the Ag layer was peeled when the tape was released (film area remaining after release/film area before release×100(%)) was obtained. The ratio was used to determine the adhesiveness of the Ag layer based on the following criteria, 5B and 4B were determined respectively as “excellent” and “good”, and 3B and inferior were determined as “failure”.

### Determination Criteria:

5B: 0% peeled (no peeling)
4B: peeling of less than 5%
3B: peeling of 5% or more and less than 15%
2B: peeling of 15% or more and less than 35%
1B: peeling of 35% or more and less than 65%
0B: peeling of 65% or more or 100%

Determination results of the respective evaluation items obtained from the electroconductive multilayer bodies of the examples, the comparative examples, and the reference examples produced in the present embodiment are shown in Table 1.

TABLE 1

| | | | Evaluation results | | |
|---|---|---|---|---|---|
| | | | | Sheet resistance | |
| | | Polymer | | value | |
| | Substrate | (Binder layer) | Appearance | (failure10-1Ω/□) | Adhesiveness |
| Example 1 | ITO Substrate | Polyacrylic acid | excellent | 3.16 | excellent |
| Example 2 | | Polyvinyl butyral | good | 5.32 | excellent |
| Example 3 | | Polyvinyl alcohol | good | 2.79 | excellent |
| Comparative | ITO Substrate | Na polyacrylate | failure | 2.77 | failure |
| Example 1 | | | | | |
| Comparative | | PVP | good | 3.27 | failure |
| Example 2 | | | | | |
| Comparative | | Ethyl cellulose | failure | 3.56 | failure |
| Example 3 | | | | | |
| Comparative | | Citric acid | failure | 12.4 | failure |
| Example 4 | | | | | |
| Comparative | | Na acetate | failure | 23.3 | failure |
| Example 5 | | | | | |
| Comparative | | Oleic acid | good | 3.24 | failure |
| Example 6 | | | | | |
| Comparative | | Oxalic acid | good | 3.02 | failure |
| Example 7 | | | | | |
| Comparative | | Oleylamine | good | 3.1 | failure |
| Example 8 | | | | | |
| Comparative | | Hexylamine | good | 2.87 | failure |
| Example 9 | | | | | |
| Comparative | | Diamine-N,N-dimethyl- | good | 3.03 | failure |
| Example 10 | | 1,3-propaneamine | | | |
| Comparative | | none | good | 3.03 | failure |
| Example 11 | | | | | |
| Reference | Glass substrate | Polyacrylic acid | good | 2.24 | failure |
| Example 1 | | | | | |
| Reference | | Polyvinyl butyral | good | 5.9 | excellent |
| Example 2 | | | | | |

It can be confirmed, based on Table 1, that the adhesiveness of the Ag layer is good (evaluation: 5B) in the electroconductive multilayer bodies produced by using, for forming the binder layer, polyacrylic acid (Example 1), polyvinyl butyral (Example 2), and polyvinyl alcohol (Example 3). The polymers applied in these examples are polymers having a main chain of a straight chain, and containing an OH group and/or a COOH group as a side chain. When a polymer having a carboxyl group modified with Na in a side chain, such as sodium polyacrylate (Comparative Example 1), is applied, the adhesiveness is inferior. Besides, it is difficult to ensure the adhesiveness by using a polymer whose main chain is not a straight chain, such as polyvinyl pyrrolidone (Comparative Example 2), or ethyl cellulose (Comparative Example 3). In addition, a binder layer for adhering the Ag layer cannot be obtained by using the monomers such as the acids and amines used in Comparative Examples 4 to 10.

Besides, the electric resistance value (sheet resistance) of the Ag layer was 10Ω/□ or less in all the samples. It is presumed that the Ag layer of the electroconductive multilayer body of each example has favorable electric characteristics of Ag regardless of the composition of the binder layer (polymer).

Referring to Reference Examples 1 and 2, the polymer effective as the binder layer in the present embodiment basically improves the adhesiveness to the ITO layer, but is not effective for the glass substrate. Only polyvinyl butyral (Reference Example 2) is effective also for glass.

Second Embodiment: In the present embodiment, conductive multilayer bodies using, as the binder layer, polyacrylic acid or polyvinyl butyral, which were found to be effective as the polymer contained in the binder layer in First Embodiment, were produced. Then, conditions were changed in the average molecular weight of the polymer, the polymer concentration in the polymer solution, whether or not the preliminary calcination was performed after applying the polymer, and the calcining temperature in forming the Ag layer.

The production process of the electroconductive multilayer body of the present embodiment was the same as that of First Embodiment. Then, in the same manner as in First Embodiment, the appearance of the Ag layer surface was evaluated, the resistance value were measured, and the adhesiveness of the Ag layer was evaluated. Evaluation results thus obtained are shown in Table 2.

TABLE 2

| | | | | | | Evaluation results | | |
|---|---|---|---|---|---|---|---|---|
| | Polymer | | | | | | Sheet | |
| | | Average | | | | | resistance | |
| | | molecular | Polymer | | Calcining | | value | |
| | | weight | concentration | Preliminary | temperature | | (failure 10 − | |
| No. | Type | (M.W) | (wt %) | calcination | (° C.) | Appearance | 1Ω/□) | Adhesiveness |
| 1 | Polyacrylic | 50000 | 1.0 | performed | 120 | good | 3.72 | excellent |
| 2 | acid | 150000 | | | | good | 3.16 | excellent |
| 3 | | 1000000 | | | | good | 3.47 | excellent |
| 4 | | 50000 | 0.5 | | | good | 3.23 | excellent |
| 5 | | 1000000 | | | | good | 3.11 | excellent |
| 6 | | 150000 | 0.1 | | | good | 2.72 | failure |
| 7 | | | 0.5 | | | good | 3.19 | excellent |
| 8 | | 150000 | 1.0 | | 40 | good | 35.5 | failure |
| 9 | | | | | 60 | good | 18.5 | good |
| 10 | | | | | 80 | good | 9.53 | excellent |
| 11 | | | | | 100 | good | 4.58 | excellent |
| 12 | | | | not performed | 120 | good | 2.71 | excellent |
| 13 | Polyvinyl | 110000 | 0.1 | performed | 120 | good | 3.29 | failure |
| 14 | butyral | | 0.5 | | | good | 3.18 | excellent |
| 15 | | | 1.0 | | | good | 5.32 | excellent |
| 16 | | | 1.0 | | 80 | good | 14.2 | excellent |
| 17 | | | | | 100 | good | 8.73 | excellent |

No. 2 corresponds to Example 1, and No. 15 corresponds to Example 2.

In the results obtained in the present embodiment, first, as for the average molecular weight of the polymer, good adhesiveness is obtained even in using polyacrylic acid having an average molecular weight of 1000000 (Nos. 3 and 5). Besides, as for the concentration of the polymer solution for forming the binder layer, it is deemed that a binder layer wholly having good adhesiveness can be formed with the concentration set to 0.5% by mass. This was confirmed because the peeling region was large and the adhesiveness was insufficient when the polymer concentration was 0.1% by mass (Nos. 6 and 13). This is probably because when the polymer concentration was too low, the polymer was difficult to be spread on the whole substrate surface, and there was a region having no binder layer. Therefore, it is preferable to form the binder layer with the concentration of the polymer solution appropriately adjusted in consideration of the size of the region where the Ag layer is to be formed.

Besides, it is deemed that the calcining temperature in the calcining treatment after applying the Ag ink is preferably 80° C. or more (Nos. 10 and 16). This is presumed not only from the viewpoint of the adhesiveness of the Ag layer but also from the resistance value of the Ag layer. It is deemed that the calcining temperature affects the progress of the sintering of the Ag layer, that is, a sintered body of the Ag particles. When the sintering temperature is increased, the sintering of the Ag particles proceeds to form a low-resistance Ag layer. When the calcining temperature in forming the Ag layer is 60° C., although the adhesiveness of the Ag layer is obtained to some extent, the resistance value is increased (No. 9), and when the calcining temperature is 40° C., not only the resistance value but also the adhesiveness are deteriorated (No. 8).

Regarding the preliminary calcination after the polymer application, the binder layer having adhesiveness can be formed without performing the preliminary calcination (No. 12). It was thus confirmed that the preliminary calcination is optional.

### INDUSTRIAL APPLICABILITY

As described so far, an electroconductive multilayer body (substrate/ITO layer/Ag layer) of the present invention includes, on an interface between an ITO layer and a Ag layer, a binder layer containing a polymer for improving adhesiveness. The electroconductive multilayer body of the present invention can maintain a stacked state with the ITO layer without easily peeling through deformation or the like of a substrate owing to adhesiveness of the Ag layer. The present invention is useful as an electrode substrate using ITO as a transparent electrode, such as a touch panel of a smartphone or a tablet.

1. An electroconductive multilayer body, comprising a substrate, an ITO layer containing indium tin oxide formed on at least a part of one surface or both surfaces of the substrate, and a Ag layer containing Ag formed on at least a part of the ITO layer, and
further comprising a binder layer containing a polymer and positioned between the ITO layer and the Ag layer,
wherein the polymer includes a polymer having a main chain of a straight chain, and having an OH group and/or a COOH group as a side chain.

2. The electroconductive multilayer body according to claim 1, wherein the Ag layer contains a sintered body of Ag particles having an average particle size of 10 nm or more and 300 nm or less.

3. The electroconductive multilayer body according to claim 1, wherein the polymer is any one of polyacrylic acid, polyvinyl acetal, and polyvinyl alcohol.

4. A method for producing the electroconductive multilayer body according to claim 1, comprising:
a step of providing an ITO substrate in which an ITO layer is formed on at least a part of one surface or both surfaces of a substrate;
a step of applying a polymer solution containing a polymer to a surface of the ITO layer of the ITO substrate to form a binder layer; and
a step of applying, to a surface of the binder layer, a Ag ink essentially containing a Ag particle and a solvent, and then calcining the resultant at 80° C. or more and 180° C. or less to form a Ag layer.

5. The electroconductive multilayer body according to claim 2, wherein the polymer is any one of polyacrylic acid, polyvinyl acetal, and polyvinyl alcohol.

6. A method for producing the electroconductive multilayer body according to claim 2, comprising:
a step of providing an ITO substrate in which an ITO layer is formed on at least a part of one surface or both surfaces of a substrate;
a step of applying a polymer solution containing a polymer to a surface of the ITO layer of the ITO substrate to form a binder layer; and
a step of applying, to a surface of the binder layer, a Ag ink essentially containing a Ag particle and a solvent, and then calcining the resultant at 80° C. or more and 180° C. or less to form a Ag layer.

7. A method for producing the electroconductive multilayer body according to claim 3, comprising:
a step of providing an ITO substrate in which an ITO layer is formed on at least a part of one surface or both surfaces of a substrate;
a step of applying a polymer solution containing a polymer to a surface of the ITO layer of the ITO substrate to form a binder layer; and
a step of applying, to a surface of the binder layer, a Ag ink essentially containing a Ag particle and a solvent, and then calcining the resultant at 80° C. or more and 180° C. or less to form a Ag layer.
